(19) United States
(12) Patent Application Publication
(10) Pub. No.: US 2026/0100198 A1
(43) Pub. Date: Apr. 9, 2026

(54) FLEXURE FOR HARD DISK DRIVE SUSPENSION AND HARD DISK DRIVE SUSPENSION

(71) Applicant: NHK SPRING CO., LTD., Yokohama-shi (JP)

(72) Inventors: Kenichi TAKIKAWA, Yokohama-shi (JP); Toshiki ANDO, Yokohama-shi (JP)

(73) Assignee: NHK SPRING CO., LTD., Yokohama-shi (JP)

(21) Appl. No.: 19/349,645

(22) Filed: Oct. 3, 2025

(30) Foreign Application Priority Data
Oct. 7, 2024 (JP) 2024-175800

(51) Int. Cl. G11B 5/48

(52) U.S. Cl. CPC G11B 5/4833; G11B 5/4826

(57) ABSTRACT

A flexure of a hard disk drive suspension according to one embodiment is a flexure which overlaps with a load beam provided in the hard disk drive suspension. The flexure includes a metal base having a first surface facing the load beam and a second surface on a side opposite to the first surface. The metal base includes a mounting portion on which a slider is mounted, a fixed portion provided at a tip side beyond the mounting portion in a longitudinal direction of the metal base and fixed to the load beam, and a pair of limiters arranged in a width direction of the metal base. each of the pair of limiters includes a planar portion facing the first surface or the second surface with a gap in a thickness direction of the metal base.

### CROSS-REFERENCE TO RELATED APPLICATIONS

This application is based upon and claims the benefit of priority from prior Japanese Patent Application No. 2024-175800, filed October 7, 2024, the entire contents of which are incorporated herein by reference.

### BACKGROUND OF THE INVENTION

### 1. Field of the Invention

The present invention relates to a flexure of a hard disk drive suspension, and the hard disk drive suspension.

### 2. Description of the Related Art

A hard disk drive (HDD) is used in an information processing apparatus such as a personal computer. The hard disk drive includes a magnetic disk which is rotatable about a spindle, a carriage which swivels about a pivot, and the like. The carriage includes an arm and is made to swivel about the pivot in a track width direction of the disk by a positioning motor such as a voice coil motor.

A hard disk drive suspension (hereinafter simply referred to as a suspension) is attached to the above-mentioned arm. The suspension includes a base plate connected to the arm, a load beam, a flexure provided along the load beam, and the like. A slider, which constitutes a magnetic head, is provided on a gimbal portion formed near a distal end of the flexure.

An element (transducer) for accessing data, i.e., for reading or writing data is provided on the slider. A head gimbal assembly is constituted by the load beam, the flexure, the slider, and the like.

In order to accommodate to the increase in the recording density of the disks, the head gimbal assembly needs to be further downsized, and the slider needs to be positioned more precisely relative to the recording surface of the disks.

Due to the demand for increased recording capacity of the hard disk drive for increased recording density, an increase in the number of magnetic disks provided in the hard disk drive (so-called multi-disking) has been promoted. Accordingly, thinner suspensions are required.

In addition, when a hard disk drive is subjected to external shocks, suppressing excessive deformation or damage of the suspension during the load/unload process of the suspension is required, and various proposals have been made (for example, JP 2021-140843 A).

However, even considering the proposal of the above patent literature, there is still room for improvement in the limiter structure.

### BRIEF SUMMARY OF THE INVENTION

Embodiments described herein aim to provide a flexure of a hard disk drive suspension and the hard disk drive suspension, capable of suppressing a decrease in reliability.

A flexure of a hard disk drive suspension according to one embodiment is a flexure which overlaps with a load beam provided in the hard disk drive suspension. The flexure comprises a metal base having a first surface facing the load beam and a second surface on a side opposite to the first surface. The metal base includes a mounting portion on which a slider is mounted, a fixed portion provided at a tip side beyond the mounting portion in a longitudinal direction of the metal base and fixed to the load beam, and a pair of limiters arranged in a width direction of the metal base. each of the pair of limiters includes a planar portion facing the first surface or the second surface with a gap in a thickness direction of the metal base.

The pair of limiters may be formed by a pair of first extending portions extending from the mounting portion. The planar portion may face the first surface of the fixed portion in the thickness direction.

Each of the pair of limiters may further include a first root portion connected to the mounting portion and a first intermediate portion between the first root portion and the planar portion. The fixed portion may be located between the first intermediate portions of the pair of limiters in the width direction.

The pair of limiters may be formed by a pair of second extensions extending from the fixed portion. The planar portion may face the second surface of the mounting portion in the thickness direction. Each of the pair of limiters may further include a second root portion connected to the fixed portion and a second intermediate portion connecting the second root portion and the planar portion.

The flexure may further comprise a wiring portion provided between the second surface of the mounting portion and the planar portion. The metal base may further include a frame portion provided on an outer side of the mounting portion. The fixed portion may be located between the mounting portion and the frame portion in the longitudinal direction.

The metal base may further include a frame portion provided on an outer side of the mounting portion. The frame portion may be located between the mounting portion and the fixed portion in the longitudinal direction. The planar portion may further face the second surface of the frame portion in the thickness direction.

The metal base may further include a frame portion provided on an outer side of the mounting portion. The pair of limiters may be formed by a pair of first extending portions extending from the mounting portion. The planar portion may face the first surface of the frame portion in the thickness direction.

Each of the pair of limiters may further include a first root portion connected to the mounting portion and a first intermediate portion connecting the first root portion and the planar portion. The fixed portion may be located between the mounting portion and the frame portion in the longitudinal direction. The frame portion may be located between the mounting portion and the fixed portion in the longitudinal direction. The flexure may further comprise a cover member formed of a resin material and provided on the planar portion.

A hard disk drive suspension according to an embodiment comprises a load beam and a flexure which overlaps with the load beam. The flexure comprises a metal base having a first surface facing the load beam and a second surface on a side opposite to the first surface.

The metal base includes a mounting portion on which a slider is mounted, a fixed portion provided at a tip side beyond the mounting portion in a longitudinal direction of the metal base and fixed to the load beam, and a pair of limiters arranged in a width direction of the metal base. each of the pair of limiters includes a planar portion facing the first surface or the second surface with a gap in a thickness direction of the metal base.

The pair of limiters may be formed by a pair of first extending portions extending from the mounting portion. The planar portion may face the first surface of the fixed portion in the thickness direction.

The pair of limiters may be formed by a pair of second extensions extending from the fixed portion. The planar portion may face the second surface of the mounting portion in the thickness direction.

The metal base may further include a frame portion provided on an outer side of the mounting portion. The pair of limiters may be formed by a pair of first extending portions extending from the mounting portion. The planar portion may face the first surface of the frame portion in the thickness direction. The hard disk drive suspension may be formed of a resin material and may further comprise a cover member provided on the planar portion.

According to the above configuration, a flexure of a hard disk drive suspension, and the hard disk drive suspension, capable of suppressing a decrease in reliability, can be provided.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a schematic perspective view showing an example of a hard disk drive.

FIG. 2 is a schematic cross-sectional view showing a part of the hard disk drive.

FIG. 3 is a schematic plan view showing a suspension according to the first embodiment.

FIG. 4 is a schematic plan view showing a flexure according to the first embodiment.

FIG. 5 is a schematic perspective view showing the flexure according to the first embodiment.

FIG. 6 is a schematic cross-sectional view showing the flexure according to the first embodiment.

FIG. 7 is a schematic plan view showing a manufacturing process of a limiter according to the first embodiment.

FIG. 8 is a schematic plan view showing the manufacturing process of the limiter according to the first embodiment.

FIG. 9 is a schematic plan view showing the manufacturing process of the limiter according to the first embodiment.

FIG. 10 is a schematic plan view showing a flexure provided in a suspension according to a second embodiment.

FIG. 11 is a schematic plan view showing a metal base in a state in which the limiter is to be formed.

FIG. 12 is a schematic plan view showing a flexure provided in a suspension according to a third embodiment.

FIG. 13 is a schematic plan view showing a metal base in a state in which the limiter is to be formed.

FIG. 14 is a schematic plan view showing a flexure provided in a suspension according to a fourth embodiment.

FIG. 15 is a schematic enlarged view showing a vicinity of limiters shown in FIG. 14.

FIG. 16 is a schematic plan view showing a metal base in a state in which the limiter is to be formed.

FIG. 17 is a schematic plan view showing a flexure provided in a suspension according to a fifth embodiment.

FIG. 18 is a schematic enlarged view showing a vicinity of limiters shown in FIG. 17.

FIG. 19 is a schematic plan view showing a metal base in a state in which the limiter is to be formed.

FIG. 20 is a schematic plan view showing a flexure provided in a suspension according to a sixth embodiment.

FIG. 21 is a schematic cross-sectional view showing the flexure shown in FIG. 20.

### DETAILED DESCRIPTION OF THE INVENTION

Each of embodiments of the invention will be described hereinafter with reference to the accompanying drawings. In order to make the description clearer, the sizes, shapes and the like of the respective parts may be changed and illustrated schematically in the drawings as compared with those in an accurate representation.

### [First Embodiment]

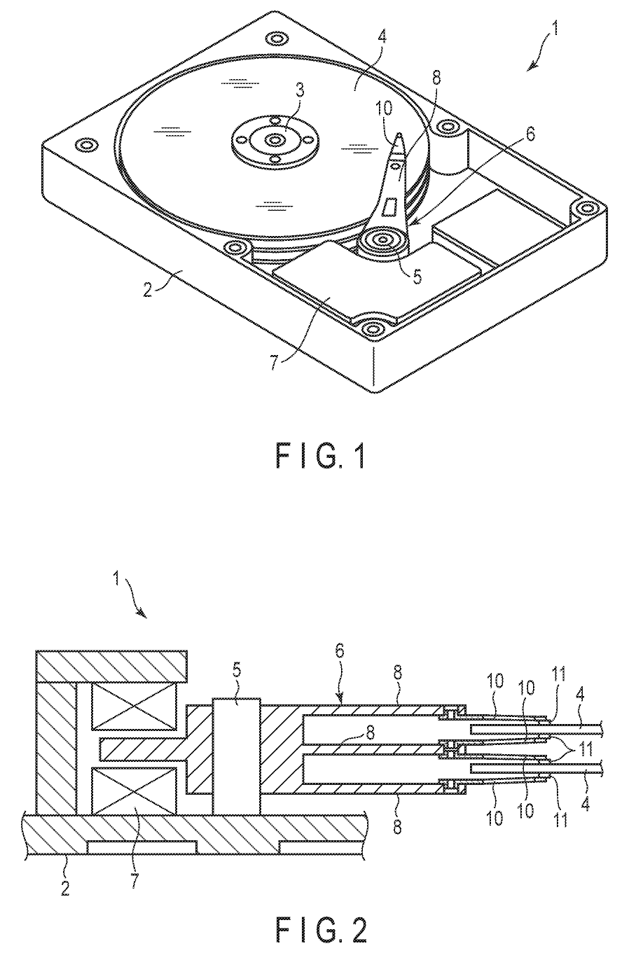

FIG. 1 is a schematic perspective view showing an example of a hard disk drive (HDD) 1. In the example shown in FIG. 1, the hard disk drive 1 comprises a casing 2, a plurality of magnetic disks (hereafter referred to simply as disks 4) rotating about a spindle 3, a carriage 6 that can swivel about a pivot 5, and a positioning motor (voice coil motor) 7 for driving the carriage 6. The casing 2 is sealed by a lid (not shown).

FIG. 2 is a schematic cross-sectional view showing a part of the hard disk drive 1. As shown in FIG. 2, a plurality of (for example, three) arms 8 are provided at the carriage 6. The quantity of arms 8 provided at the carriage 6 is not limited to the above example.

A hard disk drive suspension (hereinafter referred to as a suspension) 10 is attached to a distal end portion of each of the arms 8. In addition, a slider 11, which constitutes a magnetic head, is provided at each of distal end portions of the suspensions 10.

When each disk 4 rotates at a high speed, air flows in between the disk 4 and the slider 11, and an air bearing is thereby formed. If the carriage 6 is turned by the positioning motor 7, the suspension 10 moves in the radial direction of the disk 4, and the slider 11 thereby moves to a desired track of the disk 4.

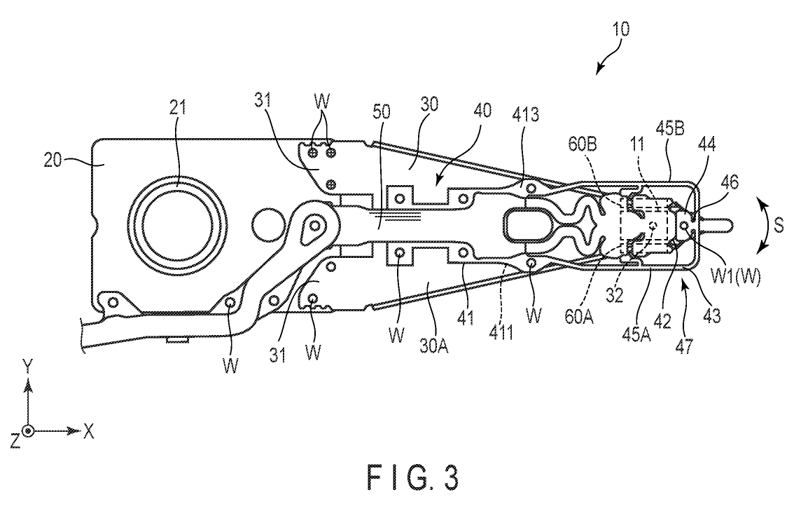

FIG. 3 is a schematic plan view showing the suspension 10 according to the present embodiment. The suspension 10 comprises a base plate 20 connected to the arm 8 (shown in FIG. 2), a load beam 30, and a flexure 40.

An X-axis, a Y-axis and a Z-axis orthogonal to each other in the figures following FIG. 3, will be described below. A direction along the X-axis is referred to as a first direction X, a direction along the Y-axis is referred to as a second direction Y, and a direction along the Z-axis is referred to as a third direction Z. Viewing various elements in a direction parallel to the third direction Z is referred to as plan view.

The first direction X corresponds to a longitudinal direction of the suspension 10, the base plate 20, the load beam 30, and the flexure 40. In the first direction X, the side where the slider constituting the magnetic head is mounted, relative to the base plate 20, is often referred to as a distal end or a distal end side.

In addition, the second direction Y corresponds to a width direction of the suspension 10, the base plate 20, the load beam 30, and the flexure 40, and the third direction Z corresponds to a thickness direction of the suspension 10, the base plate 20, the load beam 30, and the flexure 40. The length along the third direction Z is often hereinafter referred to as a thickness. Furthermore, a sway direction S indicated by an arc-shaped arrow near the distal end of the load beam 30 is defined.

The base plate 2 is formed of, for example, a metallic material such as stainless steel. The base plate 20 includes a cylindrical boss portion 21 for connecting to the arm 8 (shown in FIG. 2).

The load beam 30 is formed of a metallic material such as stainless steel. The thickness of the load beam 30 is, for example, 30 to 80 μm. The load beam 30 has a shape tapered toward the distal end.

The load beam 30 is connected to the base plate 20 at a plurality of welded portions W, for example by spot welding using a laser, as shown in FIG. 3. More specifically, the load beam 30 is elastically supported on the base plate 20 via a pair of spring portions 31 including the plurality of welded portions W. The load beam 30 has a surface 30A on which the flexure 40 is provided.

The flexure 40 is provided along the base plate 20 and the load beam 30. The flexure 40 overlaps with the surface 30A of the load beam 30. In addition, a part of the flexure 40 extends rearward beyond the base plate 20.

The flexure 40 comprises a metal base 41, and a wiring portion 50 which overlaps with the metal base 41. The metal base 41 is formed of, for example, a thin stainless steel plate. The thickness of the metal base 41 is smaller than the thickness of the load beam 30. The thickness of the metal base 41 is, for example, 15 to 20 μm.

The metal base 41 is fixed to the base plate 20 and the load beam 30 at a plurality of welded portions W, for example, by spot welding using a laser. The metal base 41 has a surface 411 (first surface) facing the surface 30A of the load beam 30 and a surface 413 (second surface) on a side opposite to the surface 411. The surface 411 faces in a direction opposite to the third direction Z, and the surface 413 faces in the third direction Z. The surface 413 corresponds to the surface on which the wiring portion 50 is provided.

The wiring portion 50 includes a base insulating layer, a conductor layer overlapping with the base insulating layer, and a cover insulating layer overlapping with the conductor layer. The conductor layer includes, for example, lines for reading and lines for writing. The plurality of lines are covered with the cover insulating layer.

The metal base 41 further includes a tongue portion 42, a frame portion 43, and a fixed portion 44 near the distal end of the suspension 10. Each of the tongue portion 42, the frame portion 43, and the fixed portion 44 is a part of the metal base 41, and its outline is formed by, for example, etching.

Each of the tongue portion 42, the frame portion 43, and the fixed portion 44 has surfaces 411 and 413. Each of the surfaces 411 and 413 is, for example, an unetched surface (rolled surface).

The center of the tongue portion 42 in the second direction Y approximately matches the center of the fixed portion 44 in the second direction Y. The center of the tongue portion 42 and the fixed portion 44 in the second direction Y approximately matches the center of the suspension 10 in the second direction Y.

A slider 11, which constitutes the magnetic head, is mounted on the tongue portion 42. In this embodiment, the tongue portion 42 corresponds to the mounting portion where the slider 11 is mounted. The tongue portion 42 includes a portion overlapping with the slider 11 and its adjacent portion. In FIG. 3, the slider 11 is represented by a dashed line. For example, an element capable of converting magnetic and electrical signals, such as an MR element, is provided at the distal end portion of the slider 11.

The wiring portion 50 is electrically connected to an element of the slider 11 via a terminal for the slider 11. Incidentally, the terminal for the slider 11 is omitted in each figure for simple illustration. Accessing data on the disk 4 (shown in FIG. 2) such as writing data or reading data is performed by these elements. A head gimbal assembly is constituted by the slider 11, the load beam 30, the flexure 40, and the like.

The frame portion 43 is provided outside the tongue portion 42 to surround the tongue portion 42. Furthermore, in the present embodiment, the frame portion 43 is provided outside the fixed portion 44 to surround the fixed portion 44.

The frame portion 43 includes a pair of outriggers 45A and 45B. In the example shown in FIG. 3, the frame portion 43 connects the outrigger 45A and the outrigger 45B at the distal end side relative to the tongue portion 42 and the fixed portion 44. The outriggers 45A and 45B are located on both sides of the tongue portion 42 in the second direction Y, respectively.

The metal base 41 is fixed to the load beam 30 by the welded portion W (shown as welded portion W1 in FIG. 3) at the fixed portion 44. The fixed portion 44 is provided on the distal end side of the tongue portion 42 in the first direction X.

The fixed portion 44 is located between the tongue portion 42 and the frame portion 43 in the first direction X. In other words, the tongue portion 42, the fixed portion 44, and the frame portion 43 are arranged in this order in the first direction X.

The fixed portion 44 is not connected to the tongue portion 42 in the first direction X. In contrast, the fixed portion 44 is connected to the frame portion 43 via the connecting portion 46 in the first direction X. The width of the connecting portion 46 in the second direction Y is smaller than the width of the fixed portion 44 in the second direction Y.

A dimple 32 (shown by a dashed line in FIG. 3) protruding toward the tongue portion 42 is formed on the load beam 30. A tip of the dimple 32 is in contact with the surface 411 at the tongue portion 42.

The tongue portion 42 is formed to be able to swing about the tip of the dimple 32 and perform a desired gimbal motion. A gimbal portion 45 is constituted by the tongue portion 42, the pair of outriggers 45A and 45B, the dimple 32, and the like.

Actuators 60A and 60B are mounted on a gimbal portion 47. The actuators 60A and 60B have a function of pivoting the tongue portion 42 in the sway direction S. The actuators 60A and 60B are, for example, piezoelectric elements and are formed of, for example, lead zirconate titanate (PZT).

The actuators 60A and 60B are provided on both sides of the slider 11 in the second direction Y. The actuators 60A and 60B are fixed to the tongue portion 42 by a conductive adhesive or the like.

The metal base 41 in the present embodiment will be described below while focusing the vicinity of the distal end of the flexure 40.

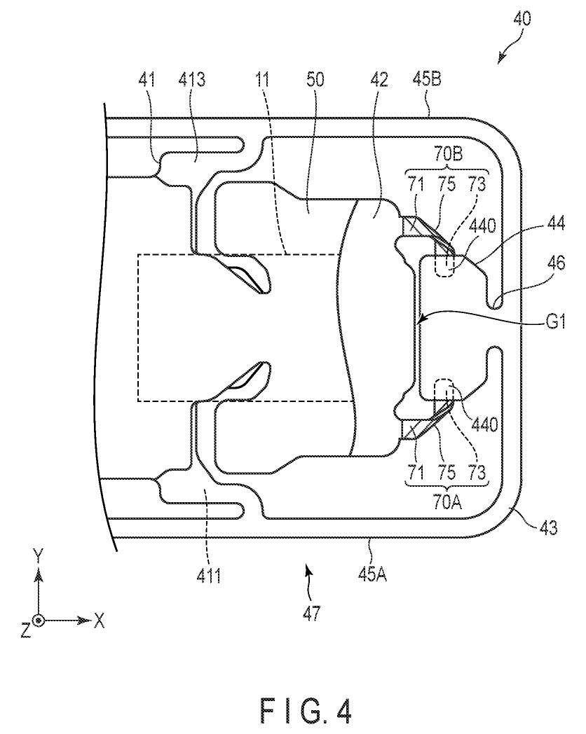

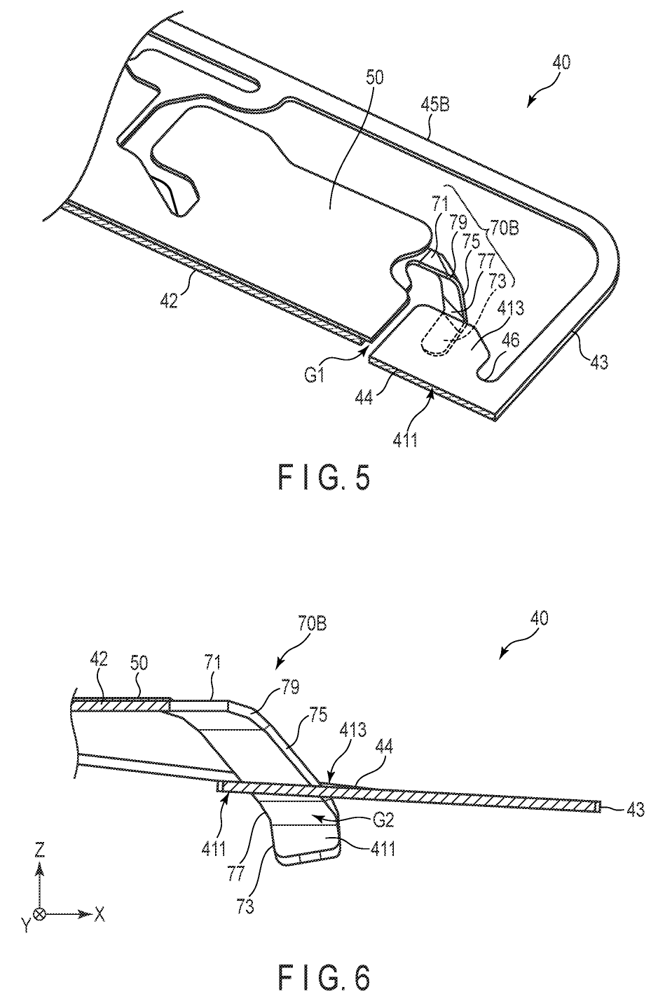

FIG. 4 is a schematic plan view showing the flexure 40 according to the present embodiment. FIG. 5 is a schematic perspective view showing the flexure 40 according to the present embodiment. FIG. 6 is a schematic cross-sectional view showing the flexure 40 according to the present embodiment.

In FIG. 4 to FIG. 6, the load beam 30 is omitted. In FIG. 4, parts of the wiring portion 50 and the slider 11 overlapping with the tongue portion 42 are shown, and illustration of the wiring portion 50 and the slider 11 overlapping with the distal side portion of the tongue portion 42 to which a limiter to be described later is connected is omitted. FIG. 5 shows a cross-section of the flexure 40. In FIG. 6, the flexure 40 is viewed in the second direction Y.

The flexure 40 comprises the metal base 41 and the wiring portion 50 as described above. The metal base 41 includes a tongue portion 42, a frame portion 43, and a fixed portion 44. A gap G1 extending in the second direction Y is formed between the tongue portion 42 and the fixed portion 44, in the first direction X, as shown in FIG. 4.

The metal base 41 further includes limiters 70A and 70B as shown in FIG. 4. In the present embodiment, the limiters 70A and 70B correspond to a pair of limiters. In the example of FIG. 5 and FIG. 6, the limiter 70B is shown.

The limiters 70A and 70B are arranged in the second direction Y. In the present embodiment, the limiters 70A and 70B extend from the tongue portion 42. Each of the limiters 70A and 70B is formed by, for example, folding a part of the metal base 41 extending from the tongue portion 42. The limiter 70A has, for example, a shape which is line-symmetric with respect to the limiter 70B with respect to a virtual straight line extending in the second direction Y.

Each of the limiters 70A and 70B includes a root portion 71 (first root portion), a planar portion 73, and an intermediate portion 75 (first intermediate portion) between the root portion 71 and the planar portion 73, as shown in FIG. 4. For example, the root portion 71, the planar portion 73, and the intermediate portion 75 are integrally formed. Each of the root portion 71, the planar portion 73, and the intermediate portion 75 has surfaces 411 and 413.

The root portion 71 is connected to the tongue portion 42. More specifically, the root portion 71 extends from the tongue portion 42 in the first direction X as shown in FIG. 4. The gap between root portions 71 adjacent in the second direction Y is greater than the width of the fixed portion 44 in the second direction Y.

The planar portion 73 faces the surface 411 or the surface 413 in the third direction Z with a gap. In this example, “facing” implies not only a case where the elements may be parallel to each other, but also a case where one element may be inclined relative to the other element. In addition, “facing each other” implies not only a case where no other elements may be provided between the elements, but also a case where other elements may be provided between the elements.

In the present embodiment, the planar portion 73 faces the surface 411 of the fixed portion 44 as shown in FIG. 6. More specifically, the surface 411 of the planar portion 73 faces the surface 411 of the fixed portion 44.

The planar portion 73 overlaps with the fixed portion 44 in plan view as shown in FIG. 4. The planar portion 73 and the fixed portion 44 are arranged in this order in the third direction Z. The tip of the planar portion 73 is located near the side part of the load beam 30 in the second direction Y, in plan view. The fixed portion 44 has a width in the second direction Y, which is greater than that of the load beam 30 in the portion overlapping with the load beam 30. The fixed portion 44 has overlapping portions 440 that overlap with the planar portion 73 at both ends in the second direction Y.

The planar portion 73 is spaced apart from the surface 411 of the fixed portion 44. In the present embodiment, as shown in FIG. 6, a gap G2 is formed in the third direction Z between the surface 411 of the planar portion 73 and the surface 411 of the fixed portion 44.

The fixed portion 44 is located between the intermediate portion 75 of the limiter 70A and the intermediate portion 75 of the limiter 70B in the second direction Y, as shown in FIG. 4. In addition, the intermediate portion 75 is not in contact with the fixed portion 44.

As shown in FIG. 4, in plan view, the planar portion 73 of the limiter 70A extends in the second direction Y relative to the fixed portion 44, and the planar portion 73 of the limiter 70B extends in a direction opposite to the second direction Y relative to the fixed portion 44.

The limiter 70B further includes a bending portion 77 which connects the intermediate portion 75 with the planar portion 73, and a bending portion 79 which connects the intermediate portion 75 with the root portion 71, as shown in FIG. 5 and FIG. 6. Although not shown, the limiter 70A also includes the bending portions 77 and 79, similarly to the limiter 70B.

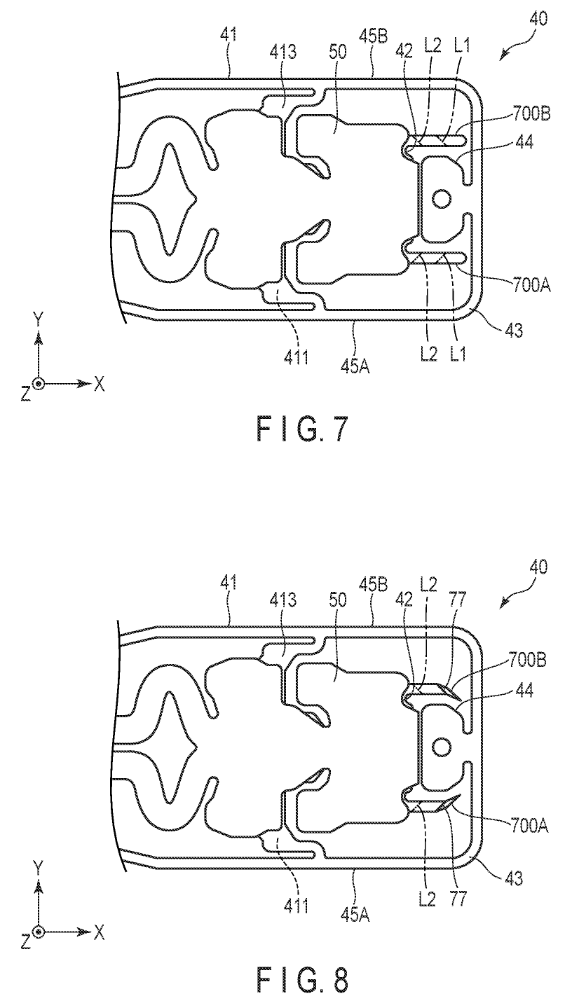

Next, an example of a method of manufacturing the limiters 70A and 70B will be described. FIG. 7 to FIG. 9 are schematic plan views showing the manufacturing process of the limiters 70A and 70B according to the present embodiment.

FIG. 7 shows the metal base 41 in a state in which the limiters 70A and 70B are to be formed. The metal base 41 has extending portions 700A and 700B, as shown in FIG. 7. In the present embodiment, the extending portions 700A and 700B correspond to a pair of first extending portions.

The limiters 70A and 70B are formed by folding the extending portions 700A and 700B. More specifically, the limiters 70A and 70B are formed by folding the extending portions 700A and 700B twice.

The extending portions 700A and 700B extend from the tongue portion 42 in the first direction X. The fixed portion 44 is located between the extending portions 700A and 700B in plan view. The extending portions 700A, the fixed portion 44, and the extending portions 700B are arranged in this order in the second direction Y.

In the example of FIG. 7, folding lines L1 and L2 indicate the positions where the extending portions 700A and 700B are to be folded. The planar portion 73 is formed on the distal end side relative to folding line L1, the intermediate portion 75 is formed between folding lines L1 and L2, and the root portion 71 is formed between folding line L2 and the tongue portion 42.

The folding lines L1 and L2 are inclined relative to the second direction Y. More specifically, the folding lines L1 and L2 of the extending portion 700A are inclined to be farther from the tongue portion 42 as they advance in the second direction Y. In contrast, the folding lines L1 and L2 of the extending portion 700B are inclined to be farther from the tongue portion 42 as they advance in a direction opposite to the second direction Y.

First, the extending portions 700A and 700B are folded at the folding lines L1. More specifically, as shown in FIG. 8, a portion closer to the distal end side than the folding line L1 is folded so as to advance in a direction opposite to the third direction Z (downward). The bending portion 77 is thereby formed.

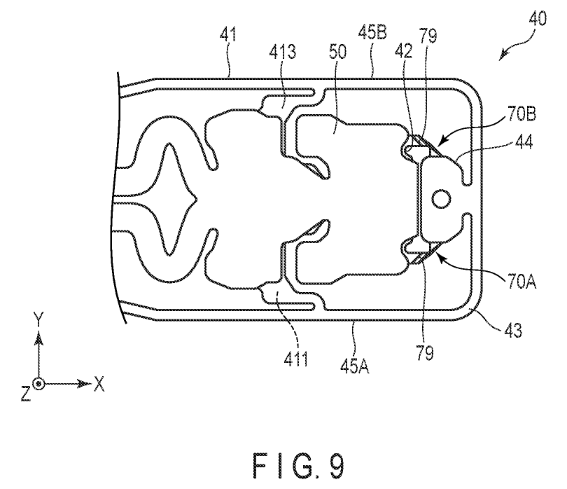

Next, the extending portions 700A and 700B are folded along the folding line L2. More specifically, as shown in FIG. 9, a portion closer to the distal end side than the folding line L2 is folded so as to advance in a direction opposite to the third direction Z (downward). The bending portion 79 is thereby formed.

As described above, by folding the extending portions 700A and 700B along the folding lines L1 and L2, respectively, the planar portion 73 is located below the fixed portion 44. As a result, the surface 411 of the planar portion 73 faces the surface 411 of the fixed portion 44.

The limiters 70A and 70B suppress the tongue portion 42 moving significantly from the dimple 32 or performing an excessive gimbal movement when the suspension 10 receives an external impact. More specifically, the planar portions 73 of the limiters 70A and 70B come into contact with the fixed portion 44, and the movement of the tongue portion 42 is thereby suppressed. The deformation or damage to the suspension 10 is thereby suppressed.

In the present embodiment, the limiters 70A and 70B of the flexure 40 include planar portions 73 that face each other with a gap G2 (shown in FIG. 6) relative to the surface 411 of the fixed portion 44 in the third direction Z. For this reason, when the suspension 10 receives an external impact, the surface 411 of the planar portion 73 comes into contact with the surface 411 of the fixed portion 44.

It is assumed that, as a flexure according to a comparative example, the edge (end surface) of the limiter faces the surface of the fixed portion 44. When the surface 411 of the planar portion 73 and the surface 411 of the fixed portion 44 come into contact, similarly to the present embodiment, the contact area can be made larger than that in the comparative example. Accordingly, the load at the time of contact is distributed, and the pressure per unit area at the time of contact is reduced. As a result, wear can be suppressed at the time of contact.

In addition, when the edge of the limiter is an etched surface, the surface 411 (rolling surface) is smoother than the etched surface, and contact area can be made larger than that in the comparative example. Accordingly, the load at the time of contact is widely distributed, and the pressure per unit area at the time of contact is reduced. Furthermore, the rolling surface is harder and less deformable than the etched surface. As a result, wear can be suppressed at the time of contact. Foreign objects such as debris and particles are generated by the wear during the contact (contamination). Generation of such foreign objects may cause the reliability of the hard disk drive to be reduced. According to the present embodiment, foreign objects are less likely to be generated compared to the above comparative example.

In particular, the flying height of the slider relative to the magnetic disk tends to be smaller. For example, a part of the magnetic head may be made to protrude or only the area around the element may be made closer to the media (magnetic disk) due to thermal expansion caused by a heater provided on the distal end side of the magnetic head.

In such a case, the gap between the slider and the magnetic disk (head media spacing) is very small (for example, 1 nm or less). In the present embodiment, since the generation of foreign particles can be suppressed, the occurrence of malfunctions in the hard disk drive caused by foreign particles can be suppressed. Thus, according to the present embodiment, the reduction in reliability of the hard disk drive can be suppressed.

In the present embodiment, the limiter structure is formed by the limiters 70A and 70B, and the fixed portion 44. Since each of the limiters 70A and 70B and the fixed portion 44 is a part of the metal base 41, the limiter structure can easily be formed. For example, the overlap between the planar portions 73 of the limiters 70A and 70B and the fixed portion 44 can easily be adjusted.

When the limiter structure is formed by the load beam and the flexure, the limiter of the flexure needs to be hooked onto a part of the load beam during the assembly. Therefore, the limiter of the flexure may not be hooked properly or may be deformed.

According to the present embodiment, a limiter structure that is less affected by the assembly accuracy of the load beam 30 and the flexible member 40 can be formed. In other words, according to the present, the assembly of the flexible member 40 and the load beam 30 becomes easier.

In addition, in the present embodiment, since the limiter 70A and 70B are formed by folding a part of the metal base 41 twice, the height of the limiter 70A and 70B can be reduced. In this example, the height refers to, for example, the length of the limiter 70A and 70B along the third direction Z.

By reducing the height of the limiters 70A and 70B, the height of the limiters 70A and 70B is less likely to affect the thickness of suspension 10, which can correspond to the increase in disks in the hard disk drive.

With the flexure 40 and the suspension 10 comprising the flexure 40 as configured as described above, the reduction in reliability can be suppressed. Additionally, various advantageous effects can be obtained from the present embodiment.

Next, other embodiments will be described. In the other embodiments described below, the same constituent elements as those in the above-described first embodiment are denoted by the same reference numerals as those of the first embodiment and their detailed descriptions may be omitted or simplified.

### [Second Embodiment]

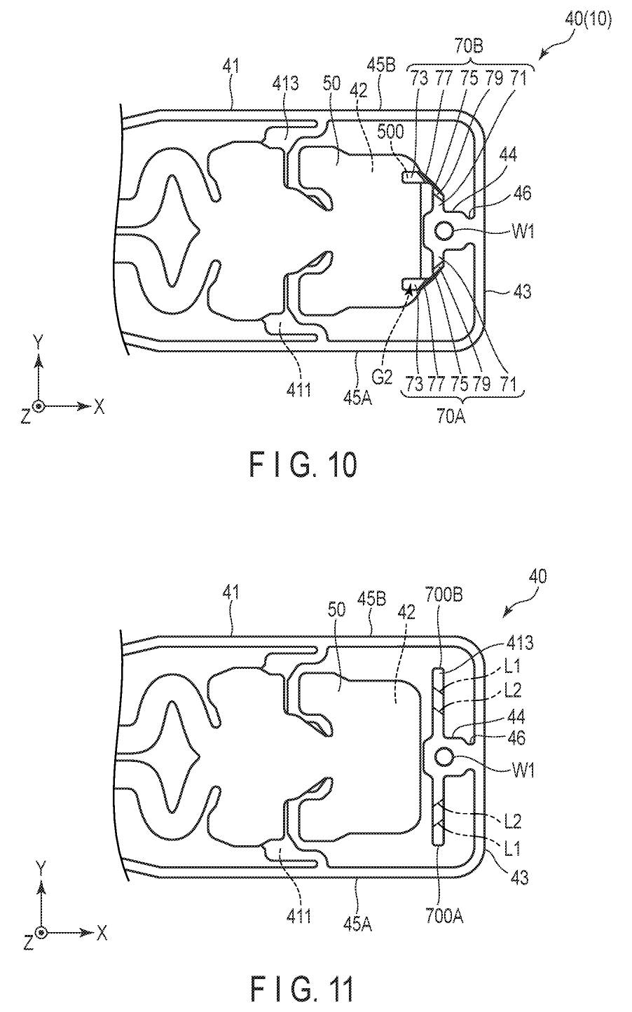

FIG. 10 is a schematic plan view showing a flexure 40 provided in a suspension 10 according to the present embodiment. The present embodiment is different from the first embodiment in that limiters 70A and 70B extend from a fixed portion 44.

Each of the limiters 70A and 70B is formed by, for example, folding a part of the metal base 41 extending from the fixed portion 44. Each of the limiters 70A and 70B includes a root portion 71 (second root portion), a planar portion 73, and an intermediate portion 75 (second intermediate portion) between the root portion 71 and the planar portion 73, as shown in FIG. 10.

The root portion 71 is connected to the fixed portion 44. The root portion 71 of the limiter 70A extends from the fixed portion 44 in a direction opposite to the second direction Y, and the root portion 71 of limiter 70B extends from the fixed portion 44 in the second direction Y. In other words, the root portion 71 of the limiter 70B extends in a direction opposite to that of the root portion 71 of the limiter 70A.

In the present embodiment, the planar portion 73 faces a surface 413 of a tongue portion 42. More specifically, the surface 413 of the planar portion 73 faces a surface 413 of the tongue portion 42 with a wiring portion 50 interposed therebetween.

In other words, a part of the wiring portion 50 is provided between the surface 413 of the tongue portion 42 and the planar portion 73. In addition, the planar portion 73 overlaps with the tongue portion 42 in plan view. The load beam 30, the tongue portion 42, the wiring portion 50, and the planar portion 73 are arranged in this order in the third direction Z. The wiring portion 50 has an overlapping portion 500 that overlaps with the planar portion 73 at the end portion near the fixed portion 44.

The planar portion 73 is spaced apart from the wiring portion 50. In the present embodiment, as shown in FIG. 10, a gap G2 is formed between the planar portion 73 and the wiring portion 50 in the third direction Z. The planar portion 73 faces the surface 413 of the tongue portion 42 with the gap G2 interposed therebetween.

The two planar portions 73 extend from their distal end sides relative to the tongue portion 42, in a direction opposite to the first direction X. The intermediate portions 75 are not in contact with the tongue portion 42. In addition, each of the limiters 70A and 70B further includes a bending portion 77 which connects the intermediate portion 75 with the planar portion 73, and a bending portion 79 which connects the intermediate portion 75 with the root portion 71.

Next, an example of a method of manufacturing the limiters 70A and 70B in the present embodiment will be described. FIG. 11 is a schematic plan view showing the metal base 41 in a state in which the limiters 70A and 70B are to be formed.

The metal base 41 includes the extending portions 700A and 700B as shown in FIG. 11. In the present embodiment, the extending portions 700A and 700B correspond to a pair of second extending portions. The limiters 70A and 70B are formed by folding the extending portions 700A and 700B. More specifically, the limiters 70A and 70B are formed by folding the extending portions 700A and 700B twice.

The extending portion 700A extends from the fixed portion 44 in a direction opposite to the second direction Y, and the extending portion 700B extends from the fixed portion 44 in the second direction Y. The extending portions 700A and 700B are located between the tongue portion 42 and the frame portion 43 in the first direction X.

In the example of FIG. 11, folding lines L1 and L2 indicate the positions where the extending portions 700A and 700B are to be folded. The planar portion 73 is formed on the distal end side relative to folding line L1, the intermediate portion 75 is formed between folding lines L1 and L2, and the root portion 71 is formed between folding line L2 and the tongue portion 42. The folding lines L1 and L2 are inclined relative to the first direction X. More specifically, the folding lines L1 and L2 are inclined so as to be closer to the fixed portion 44 as they advance in the first direction X.

First, the extending portions 700A and 700B are folded at the folding lines L1. More specifically, the portions closer to the distal end side than the folding lines L1 are folded toward the third direction Z (upward). The bending portion 77 is thereby formed.

Next, the extending portions 700A and 700B are folded along the folding line L2. More specifically, the portions closer to the distal end side than the folding lines L2 are folded toward the third direction Z (upward). The bending portion 79 is thereby formed. The limiters 70A and 70B shown in FIG. 10 are thereby formed.

The extending portions 700A and 700B are folded at the folding lines L1 and L2, respectively, and the planar portion 73 is thereby located above the wiring portion 50. As a result, the planar portion 73 faces the wiring portion 50.

In the present embodiment, the limiter structure is formed by the limiters 70A and 70B, and the fixed portion 44. In the configuration of the present embodiment, too, the same advantages as those of the first embodiment can be obtained. In addition, in the present embodiment, the surface 413 of the planar portion 73 faces the wiring portion 50.

For this reason, when the suspension 10 receives an external impact, the surface 413 of the planar portion 73 comes into contact with the upper surface of the wiring portion 50. Since the upper surface of the wiring portion 50 is formed of a soft resin material (for example, polyimide), the contact area with the surface 413 can be increased. Accordingly, the load at the time of contact is distributed, and the pressure per unit area at the time of contact is reduced. As a result, wear during contact is suppressed, and foreign objects can hardly be generated.

In addition, in the present embodiment as well, since the limiter 70A and 70B are formed by folding a part of the metal base 41 twice, the height of the limiter 70A and 70B can be reduced. Reduction in the height of the limiters 70A and 70B can correspond to a slider with a smaller thickness. In other words, by reducing the height of the limiters 70A and 70B, the protrusion of the limiters 70A and 70B in the third direction Z relative to the slider can be suppressed.

### [Third Embodiment]

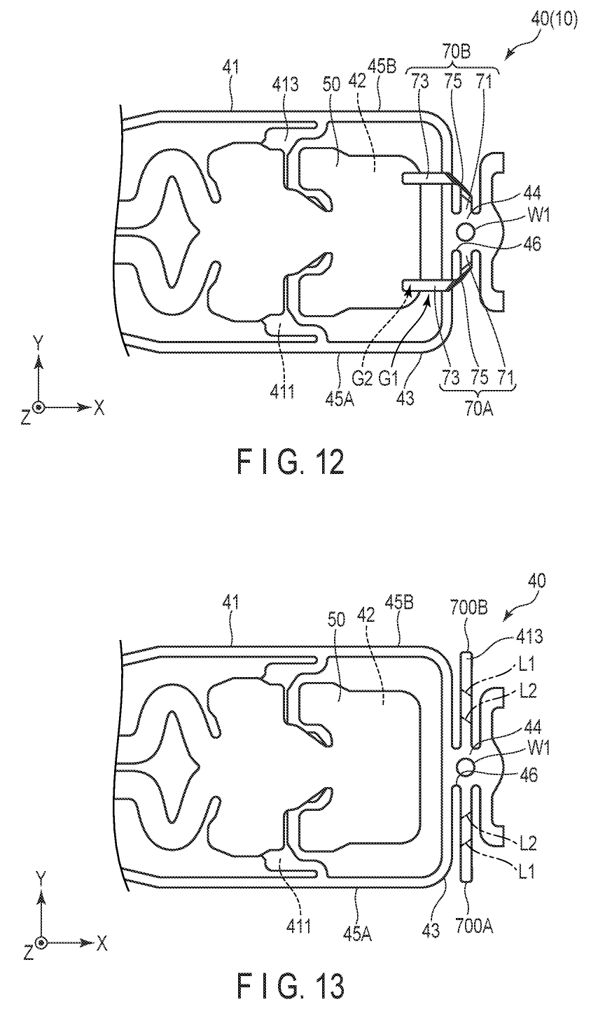

FIG. 12 is a schematic plan view showing a flexure 40 provided in a suspension 10 according to the present embodiment. The present embodiment is different from the second embodiment in arrangement of a frame portion 43 and a fixed portion 44.

In the present embodiment, the frame portion 43 is located between a tongue portion 42 and the fixed portion 44 in the first direction X. In other words, the tongue portion 42, the frame portion 43, and the fixed portion 44 are arranged in this order in the first direction X. A connecting portion 46 extends from the frame portion 43 in the first direction X.

A gap G1 extending in the second direction Y is formed between the tongue portion 42 and the frame portion 43, in the first direction X. In other words, the frame portion 43 is not connected to the tongue portion 42 in the first direction X.

Each of the limiters 70A and 70B includes a root portion 71 (second root portion), a planar portion 73, and an intermediate portion 75 (second intermediate portion) between the root portion 71 and the planar portion 73, as shown in FIG. 12.

The length of the planar portion 73 in the first direction X in the present embodiment is longer than the length of the planar portion 73 in the first direction X in the second embodiment. In the present embodiment, the planar portion 73 faces a surface 413 of a tongue portion 42. More specifically, the surface 413 of the planar portion 73 faces the surface 413 with the wiring portion 50 interposed therebetween. Furthermore, the surface 413 of the planar portion 73 faces the surface 413 of the frame portion 43 in the third direction Z.

FIG. 13 is a schematic plan view showing the metal base 41 in a state in which the limiters 70A and 70B are to be formed. The tongue portion 42, the frame portion 43, and the extending portions 700A and 700B are arranged in this order in the first direction X.

In the present embodiment as well, the extending portions 700A and 700B are folded at the folding lines L1 and L2, respectively, and the planar portion 73 is thereby located above the wiring portion 50. As a result, the planar portion 73 faces the wiring portion 50.

In the configuration of the present embodiment as well, the same advantages as those of the second embodiment can be obtained. In the present embodiment, the surface 413 of the planar portion 73 faces not only the wiring portion 50, but also the surface 413 of the frame portion 43. In other words, the planar portion 73 overlaps with the metal base 41 over a larger area compared to the second embodiment. As a result, the movement of the tongue portion 42 can be suppressed more easily.

### [Fourth Embodiment]

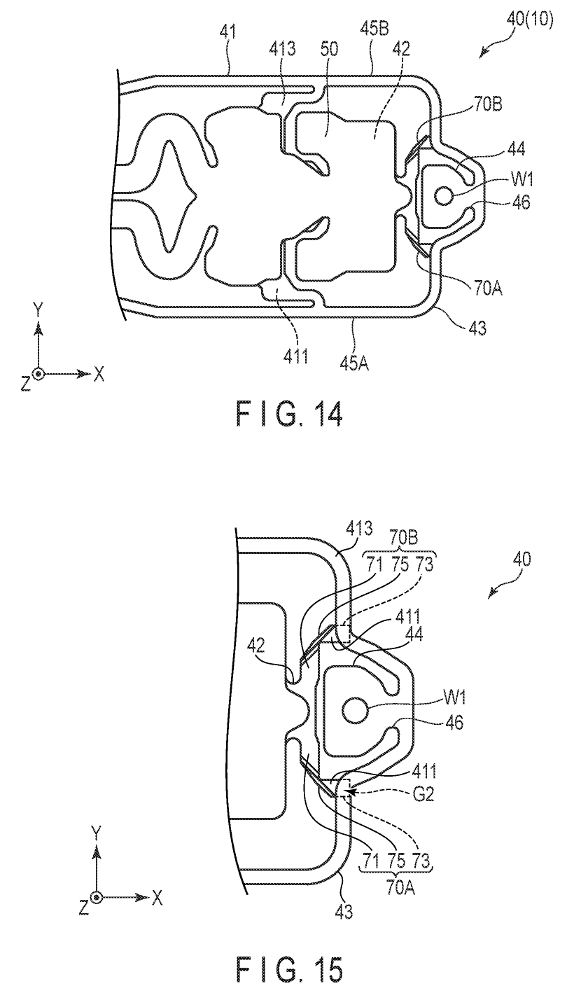

FIG. 14 is a schematic plan view showing a flexure 40 provided in a suspension 10 according to the present embodiment. FIG. 15 is a schematic enlarged view showing a vicinity of limiters 70A and 70B shown in FIG. 14. The present embodiment is different from the first embodiment in an element which a planar portion 73 faces.

The frame portion 43 has a shape which is convex in the first direction X in plan view. More specifically, a central portion in the second direction Y (i.e., a portion overlapping with the fixed portion 44 in the first direction X), of the portion connecting the outriggers 45A and 45B of the frame portion 43 protrudes in the first direction X.

In the present embodiment, the limiters 70A and 70B extend from the distal end portion of the tongue portion 42. Each of the limiters 70A and 70B is formed by, for example, folding a part of the metal base 41 extending from the tongue portion 42.

The root portion 71 of the limiter 70A extends from the fixed portion 44 in a direction opposite to the second direction Y, and the root portion 71 of limiter 70B extends from the fixed portion 44 in the second direction Y. In the present embodiment, surfaces 411 of planar portions 73 of the limiters 70A and 70B face a surface 411 of the frame portion 43, as shown in FIG. 15.

A planar portion 73 overlaps with the frame portion 43 in plan view. The planar portion 73 and the frame portion 43 are arranged in this order in the third direction Z.

The planar portion 73 is spaced apart from the surface 411 of the frame portion 43. In the present embodiment, as shown in FIG. 15, a gap G2 is formed between the planar portion 73 and the surface 411 of the frame portion 43 in the third direction Z. The intermediate portions 75 are not in contact with the frame portion 43.

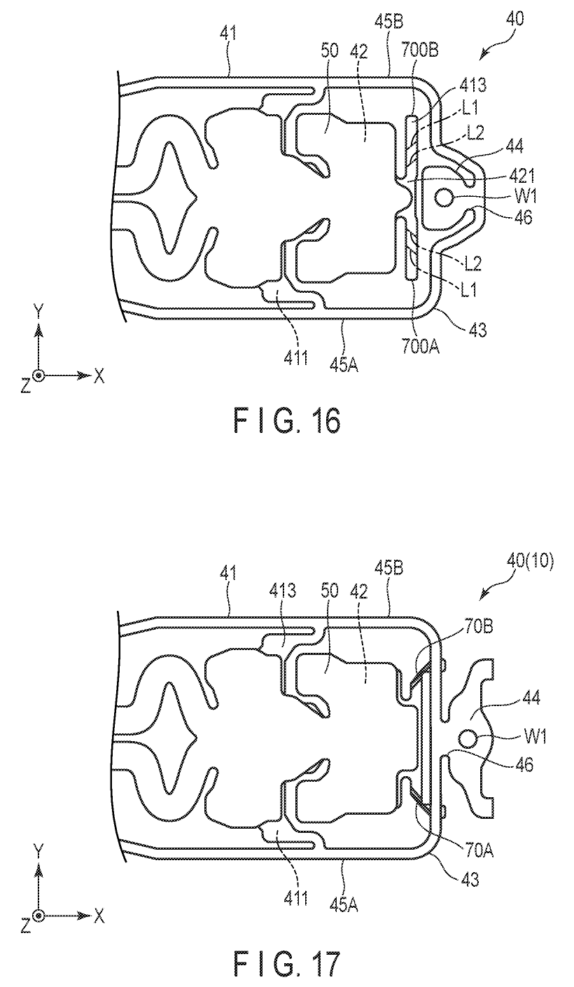

FIG. 16 is a schematic plan view showing the metal base 41 in a state in which the limiters 70A and 70B are to be formed. In the present embodiment, the extending portions 700A and 700B correspond to a pair of first extending portions.

The extending portion 700A extends from the distal end portion 421 of the tongue portion 42 in a direction opposite to the second direction Y, and the extending portion 700B extends from the distal end portion 421 of the tongue portion 42 in the second direction Y. The tongue portion 42, the extending portions 700A and 700B, and the frame portion 43 are arranged in this order in the first direction X.

The folding lines L1 and L2 are inclined to be farther from the distal end portion 421 as they advance in the first direction X. By folding the extending portions 700A and 700B at the folding lines L1 and L2, respectively, the planar portion 73 is located below the frame portion 43. As a result, the planar portion 73 faces the surface 411 of the frame portion 43.

In the configuration of the present embodiment, too, the same advantages as those of the first embodiment can be obtained. Incidentally, the planar portion 73 may protrude in the first direction X relative to the frame portion 43 in plan view.

### [Fifth Embodiment]

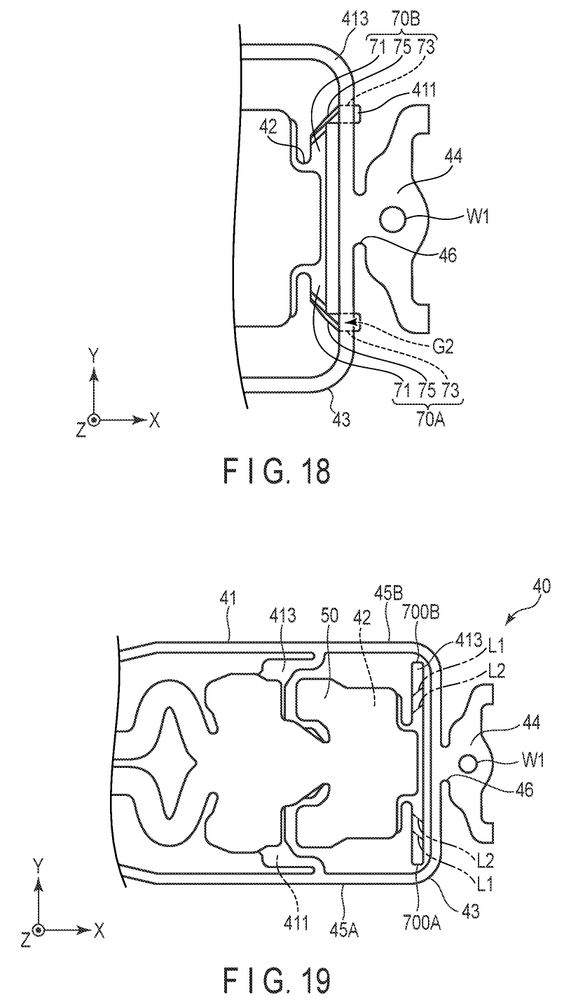

FIG. 17 is a schematic plan view showing a flexure 40 provided in a suspension 10 according to the present embodiment. FIG. 18 is a schematic enlarged view showing a vicinity of limiters 70A and 70B shown in FIG. 17. The present embodiment is different from the fourth embodiment in arrangement of a frame portion 43 and a fixed portion 44.

In the present embodiment, the frame portion 43 is located between a tongue portion 42 and the fixed portion 44 in the first direction X. In other words, the tongue portion 42, the frame portion 43, and the fixed portion 44 are arranged in this order in the first direction X. A connecting portion 46 extends from the frame portion 43 in the first direction X.

A planar portion 73 overlaps with the frame portion 43 in plan view. The planar portion 73 and the frame portion 43 are arranged in this order in the third direction Z. In addition, the planar portion 73 protrudes in the first direction X relative to the frame portion 43 in plan view, but may not necessarily protrude. In the present embodiment, as shown in FIG. 18, a gap G2 is formed between the planar portion 73 and the surface 411 of the frame portion 43 in the third direction Z.

FIG. 19 is a schematic plan view showing the metal base 41 in a state in which the limiters 70A and 70B are to be formed. The tongue portion 42, the extending portions 700A and 700B, and the frame portion 43 are arranged in this order in the first direction X.

In the present embodiment as well, the extending portions 700A and 700B are folded at the folding lines L1 and L2, respectively, and the planar portion 73 is thereby located below the frame portion 43. As a result, the planar portion 73 faces the surface 411 of the frame portion 43.

In the configuration of the present embodiment, too, the same advantages as those of the fourth embodiment can be obtained.

### [Sixth Embodiment]

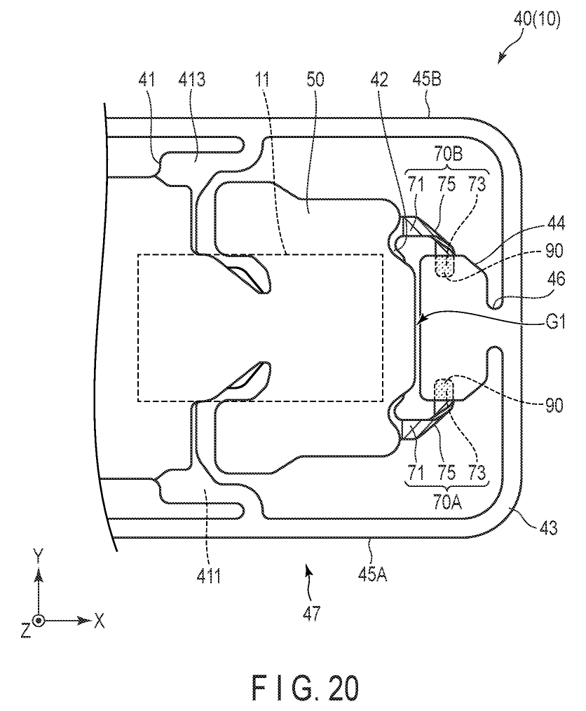

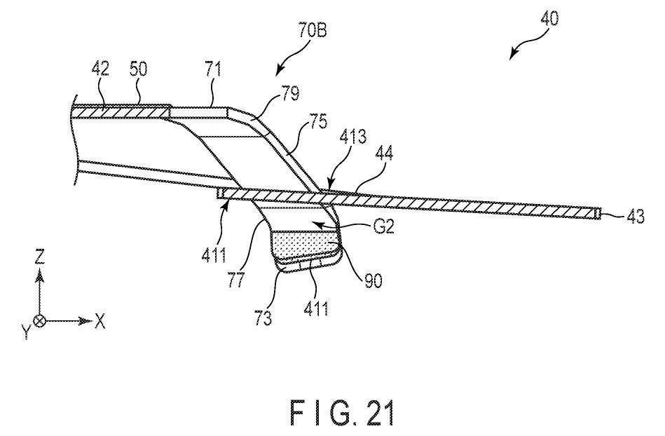

FIG. 20 is a schematic plan view showing a flexure 40 provided in a suspension 10 according to a sixth embodiment. FIG. 21 is a schematic cross-sectional view showing the flexure 40 shown in FIG. 20.

The present embodiment is different from the first embodiment in that the flexure 40 further comprises a cover member 90. In FIG. 20 and FIG. 21, the cover member 90 is marked with dots. The cover member 90 is formed of a resin material (for example, polyimide).

The cover member 90 is provided on each of the planar portions 73 of the limiters 70A and 70B. The cover member 90 is provided on at least a part of the planar portion 73. In the present embodiment, the cover member 90 is provided on a surface 411 of the planar portion 73. For example, the cover member is provided so as to overlap with the entire surface 411 of the planar portion 73.

In addition, the cover member may not be provided on the only planar portion 73, but may be further provided on at least a part of the root portion 71 and the intermediate portion 75. The cover member 90 faces a surface 411 of the fixed portion 44, as shown in FIG. 21. A gap G2 is formed between the cover member 90 and the surface 411 of the fixed portion 44 in the third direction Z.

In the configuration of the present embodiment, too, the same advantages as those of the first embodiment can be obtained. In the present embodiment, the cover member 90 arranged on the planar portion 73 is further provided. The cover member 90 faces the surface 411 of the fixed portion 44 as described above.

For example, when receiving an external impact, the cover member 90 comes into contact with the surface 411. Therefore, the generation of foreign objects can be further suppressed as compared to a case where elements formed of metal materials come into contact with each other as described in the first embodiment.

Incidentally, the cover member 90 of the present embodiment can be applied to the flexible member 40 in each of the second to fifth embodiments.

For example, the cover member 90 is provided on the surface 413 of the planar portion 73, in the second and third embodiments. In this case, the cover member 90 faces the surface 413 of the tongue portion 42 with the wiring portion 50 interposed therebetween. In other words, the elements formed of resin materials face each other.

In addition, in the third embodiment, the cover member 90 also faces the surface 413 of the frame member 43. Therefore, the generation of foreign objects can be further suppressed as compared to a case where elements formed of metal materials come into contact with each other.

The cover member 90 is provided on the surface 411 of the planar portion 73, in the fourth and fifth embodiments. In this case, the cover member 90 faces the surface 411 of the frame portion 43. As described here, the cover member 90 faces either the surface 411 or the surface 413 of the metal base 41.

In implementing each of the embodiments described above, the specific configuration of each element constituting the hard disk drive, including the specific configuration of the load beam, the flexure, and the like can be modified in various manners.

Various aspects of the invention can also be extracted from any appropriate combination of constituent elements disclosed in the embodiments. Some constituent elements may be deleted in all of the constituent elements disclosed in the embodiments. The constituent elements described in different embodiments may be combined arbitrarily.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

WHAT IS CLAIMED IS:

1. A flexure of a hard disk drive suspension, the flexure overlapping with a load beam provided in the hard disk drive suspension, and comprising:
a metal base having a first surface facing the load beam and a second surface on a side opposite to the first surface, wherein
the metal base includes:
a mounting portion on which a slider is mounted;
a fixed portion provided on a distal end side beyond the mounting portion in a longitudinal direction of the metal base, and fixed to the load beam; and
a pair of limiters arranged in a width direction of the metal base, and
each of the pair of limiters includes a planar portion facing the first surface or the second surface with a gap in a thickness direction of the metal base.

2. The flexure according to claim 1, wherein
the pair of limiters is formed by a pair of first extending portions extending from the mounting portion, and
the planar portion faces the first surface of the fixed portion in the thickness direction.

3. The flexure according to claim 2, wherein
each of the pair of limiters further includes a first root portion connected to the mounting portion and a first intermediate portion between the first root portion and the planar portion.

4. The flexure according to claim 3, wherein
the fixed portion is located between the first intermediate portions of the pair of limiters in the width direction.

5. The flexure according to claim 1, wherein
the pair of limiters is formed by a pair of second extending portions extending from the fixed portion, and
the planar portion faces the second surface of the mounting portion in the thickness direction.

6. The flexure according to claim 5, wherein
each of the pair of limiters further includes a second root portion connected to the fixed portion and a second intermediate portion connecting the second root portion and the planar portion.

7. The flexure according to claim 6, further comprising:
a wiring portion provided between the second surface of the mounting portion and the planar portion.

8. The flexure according to claim 7, wherein
the metal base further includes a frame portion provided on an outer side of the mounting portion, and
the fixed portion is located between the mounting portion and the frame portion in the longitudinal direction.

9. The flexure according to claim 7, wherein
the metal base further includes a frame portion provided on an outer side of the mounting portion,
the frame portion is located between the mounting portion and the fixed portion in the longitudinal direction, and
the planar portion further faces the second surface of the frame portion in the thickness direction.

10. The flexure according to claim 1, wherein
the metal base further includes a frame portion provided on an outer side of the mounting portion,
the pair of limiters is formed by a pair of first extending portions extending from the mounting portion, and
the planar portion faces the first surface of the frame portion in the thickness direction.

11. The flexure according to claim 10, wherein
each of the pair of limiters further includes a first root portion connected to the mounting portion and a first intermediate portion connecting the first root portion with the planar portion.

12. The flexure according to claim 11, wherein
the fixed portion is located between the mounting portion and the frame portion in the longitudinal direction.

13. The flexure according to claim 11, wherein
the frame portion is located between the mounting portion and the fixed portion in the longitudinal direction.

14. The flexure according to claim 1, further comprising:
a cover member formed of a resin material and provided on the planar portion.

15. A hard disk drive suspension comprising:
a load beam; and
a flexure overlapping with the load beam, wherein
the flexure comprises a metal base having a first surface facing the load beam and a second surface on a side opposite to the first surface,
the metal base includes:
a mounting portion on which a slider is mounted;
a fixed portion provided on a distal end side beyond the mounting portion in a longitudinal direction of the metal base, and fixed to the load beam; and
a pair of limiters arranged in a width direction of the metal base, and
each of the pair of limiters includes a planar portion facing the first surface or the second surface with a gap in a thickness direction of the metal base.

16. The hard disk drive suspension according to claim 15, wherein
the pair of limiters is formed by a pair of first extending portions extending from the mounting portion, and
the planar portion faces the first surface of the fixed portion in the thickness direction.

17. The hard disk drive suspension according to claim 15, wherein
the pair of limiters is formed by a pair of second extending portions extending from the fixed portion, and
the planar portion faces the second surface of the mounting portion in the thickness direction.

18. The hard disk drive suspension according to claim 15, wherein
the metal base further includes a frame portion provided on an outer side of the mounting portion,
the pair of limiters is formed by a pair of first extending portions extending from the mounting portion, and
the planar portion faces the first surface of the frame portion in the thickness direction.

19. The hard disk drive suspension according to claim 15, further comprising:
a cover member formed of a resin material and provided on the planar portion.
